(19) United States
(12) Patent Application Publication
(10) Pub. No.: US 2009/0251424 A1
(43) Pub. Date: Oct. 8, 2009

(54) SYSTEMS AND METHODS FOR CONTROLLING AN ELECTRONIC DEVICE VIA A TOUCH PANEL

(75) Inventor: XIANG-YU CHEN, Nanjing City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/261,039

(22) Filed: Oct. 30, 2008

(30) Foreign Application Priority Data
Apr. 3, 2008 (CN) 200810300841.9

(51) Int. Cl. G06F 3/041

(52) U.S. Cl. 345/173

(57) ABSTRACT

A method for controlling an electronic device via a touch panel includes defining a relationship between a contact activity and a pointer action, setting activation of a pointer corresponding to a contact activity, synchronizing the contact activity and the pointer action, acquiring analog signals of the contact on the touch panel, converting the analog signals into the digital signals, and controlling the pointer action according to the digital signals. A related system and storage medium with instructions for performance of the method also provided.

### BACKGROUND

1. Field of the Invention

Embodiments of the present disclosure are related to systems and methods for electronic device control, and particularly to a system and method for controlling the electronic device via a touch panel.

2. Description of Related Art

Presently, electronic devices such as personal digital assistants, Global Positioning System (GPS) consoles, or personal computers (PC) can use contact screens, display screens allowing input of data via contact therewith, increasing convenience for the user.

However, display screens of most electronic devices use liquid crystal display (LCD) technology, increasing device costs. Moreover, stylus operation on the LCD touch panel can deteriorate surface integrity thereof, resulting in reduction of lifespan of the LCD touch panel.

What is needed, therefore, is a system and method for controlling an electronic device via a touch panel to overcome the described limitations.

### SUMMARY

A method for controlling an electronic device via a touch panel is provided. The method includes initiating display of a pointer on a display screen, defining a relationship between a contact activity on the touch panel and a pointer action on the display screen, setting a movement speed threshold for controlling a movement speed of the pointer action according to a movement speed of the contact activity on the touch panel, initiating selection of the pointer corresponding to a contact, synchronizing the contact activity and the pointer action, acquiring analog signals of the contact activity on the touch panel, converting the analog signals of the contact into digital signals, controlling the pointer action according to the digital signals, and controlling the selection of the pointer according to the digital signals of the contact on the touch panel.

Other objects, advantages and novel features will become more apparent from the following detailed description of certain embodiments of the present disclosure when taken in conjunction with the accompanying drawings, in which:

### BRIEF DESCRIPTION OF THE DRAWINGS

FIG. 1 is a block diagram of an embodiment of an electronic device with a display screen and a touch panel.

FIG. 2 is a block diagram of an embodiment of a system for controlling an electronic device via a touch panel.

FIG. 3 is a flowchart of an embodiment of a method for controlling an electronic device via a touch panel.

### DETAILED DESCRIPTION OF CERTAIN INVENTIVE EMBODIMENTS

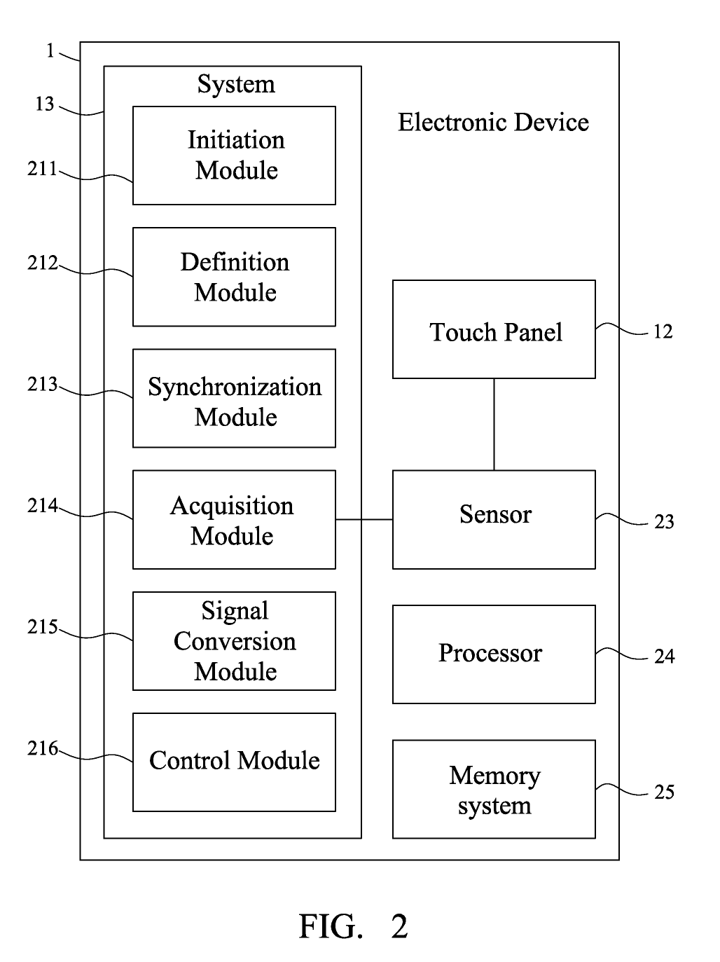

All of the processes described may be embodied in, and fully automated via, software code modules executed by one or more general purpose computers or processors as depicted in FIG. 2. The code modules may be stored in any type of computer-readable medium or other storage device. Some or all of the methods may alternatively be embodied in specialized computer hardware or electronic apparatus.

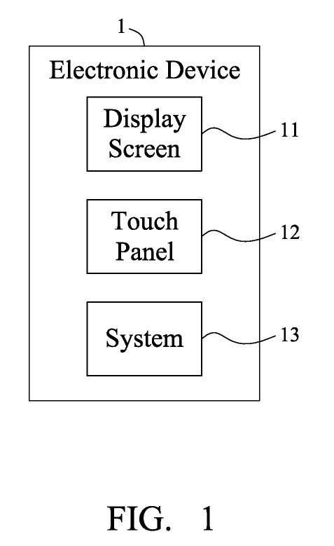

FIG. 1 is a block diagram of an embodiment of an electronic device 1 including a display screen 11, a touch panel 12, and a system 13. In this embodiment, the electronic device 1 is a portable electronic device, but may alternatively be a query terminal device, a Point Of Sale (POS) device, a retail cashier device, an Automatic Teller Machine (ATM), or other devices without limiting the scope of the disclosure. The system 13 is configured for controlling the electronic device via the touch panel 12, and displaying corresponding actions on the display screen 11.

Depending on the embodiment, the display screen 11 may be, but is not limited to, a Thin film transistor (TFT) screen, a Thin film diode (TFD) screen, a Ultra Fine Bright (UFB) screen, a Super-twisted nematic (STN) screen, a Color Super-twisted nematic (CSTN) screen, a Dual-layer super-twisted nematic (DSTN) screen, an Organic light emitting diode (OLED) screen, or a Field emitting diode (FED) screen. Additionally, the display screen 11 displays a pointer.

The touch panel 12 controls action of the pointer. Activation of the pointer on the display screen 11 is realized through contact with the touch panel 12, as is action of the pointer on the display screen 11. The contact with the touch panel 12 further confirms activation of the pointer, resulting in an instruction to an operating system and software applications of the electronic device 1.

FIG. 2 is a block diagram of an embodiment of a system for controlling an electronic device via a touch panel. The electronic device 1 includes the touch panel 12, a sensor 23, a processor 24, a memory system 25, and the system 13 for controlling an electronic device via the touch panel 12. The sensor 23, connected to the touch panel 12, acquires analog signals of the contact with the touch screen 12.

The system 13 includes an initiation module 211, a definition module 212, a synchronization module 213, an acquisition module 214, a signal conversion module 215, and a control module 216. The modules 211, 212, 213, 214, 215, 216 may execute one or more operations for the system 13. Additionally, the electronic device 1 may comprise one or more specialized or general purpose processors, such as the processor 24 for executing the modules 211, 212, 213, 214, 215, 216.

The initiation module 211 is configured for initiating display of the pointer on the display screen 11. The pointer provides a control of the operating system and the software applications of the electronic device 1.

The definition module 212 is configured for defining a relationship between contact activity on the touch panel 12 and a corresponding pointer action on the display screen 11, and setting an activation of the pointer on the display screen 11 accordingly. For example, the definition module 212 may define a relationship between the contact action from the left side to the center of the touch panel 12 to a corresponding action of the pointer on the display screen 11. Additionally, data about the relationship between the contact activity and the corresponding pointer action may be stored in the memory system 25. The memory system 25 may be a hard disk drive, a flash memory, or any other kind of memory storage systems.

The synchronization module 213 is configured for synchronizing the contact activity on the touch panel 12 with pointer actions on the display screen 11.

The acquisition module 214, connected to the sensor 23, is configured for acquiring the analog signals of the contact on the touch panel 12.

The signal conversion module 215 is configured for converting the analog signals of the contact into digital signals.

The control module 216 is configured for controlling the pointer actions and activation on the display screen 11 according to the digital signals of the contacts on touch panel 12. In this embodiment, the pointer action and the activation of the pointer provide instructions to an operating system and software applications of the electronic device. Additionally, the definition module 212 is also configured for setting a movement speed threshold for controlling a movement speed of the pointer action on the display screen 11 according to a movement speed of the contact activity on the touch panel 12. The movement speed threshold is stored in the memory system 25. In this embodiment, the control module 216 is also configured for determining if the pointer continues moving according to the speed of the contact activity relative to the movement speed threshold. As an example, if the movement speed of the contact activity is faster than the movement speed threshold, the control module 216 controls the pointer to move quickly accordingly and directs the pointer to continue moving in a constant direction until the user touches the touch panel 12 again later, and if the movement speed of the contact activity is slower than the movement speed threshold, the control module 216 controls the pointer to move slowly accordingly and directs the pointer not continue moving in the constant direction. One exemplary example of controlling the electronic device via the touch panel is detailed below.

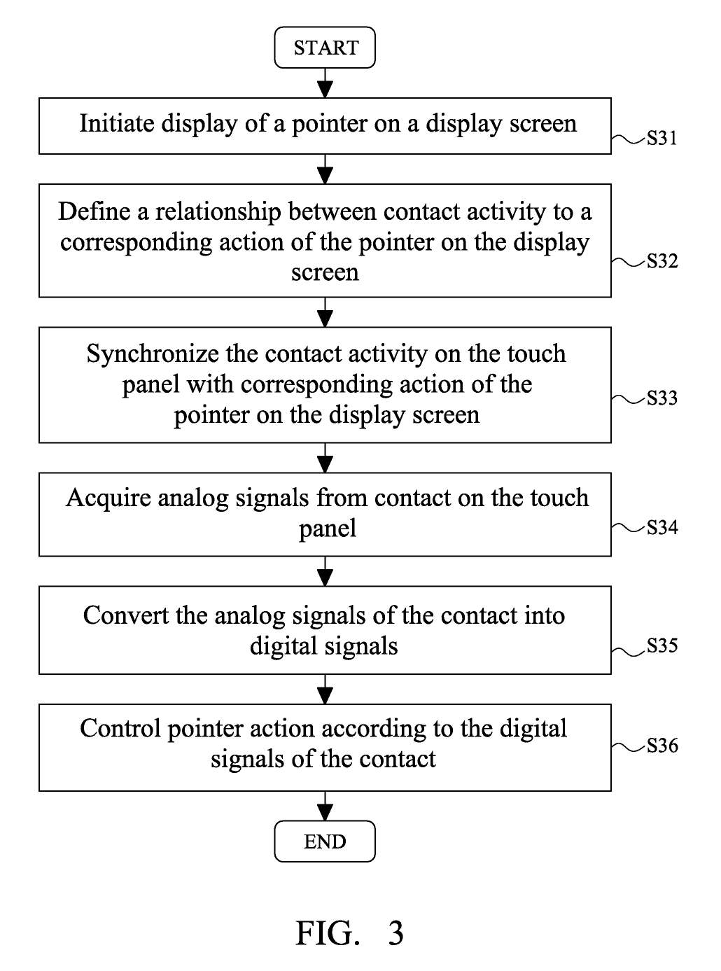

FIG. 3 is a flowchart of an embodiment of a method for controlling an electronic device via a touch panel. Additional blocks may be added or deleted and blocks may be executed in a different order than that described without deviating from the spirit of the disclosure. First, in block S31, the initiation module 211 initiates the display of the pointer on the display screen 11.

In block S32, the definition module 212 defines a relationship between the contact activity on the touch panel 12 and the corresponding pointer action on the display screen 11, and sets the initiation of the pointer on the display screen 11 accordingly. For example, the definition module 212 may define the relationship between the contact activity from the left side to the center of the touch panel 12 to the corresponding action of the pointer on the display screen 11. As mentioned previously, data about the relationship between the contact activity and he corresponding pointer action may be stored in the memory system 25.

In block S33, the synchronization module 213 synchronizes the contact activity on the touch panel 12 with corresponding pointer action on the display screen 11.

In block S34, the acquisition module 214 acquires the analog signals of the contact on the touch panel 12.

In block S35, the signal conversion module 215 converts the analog signals of the contact into the digital signals.

In block S36, the control module 216 controls the pointer action according to the digital signals of the contact. The process is complete. As mentioned previously, in this embodiment, the pointer action and the activation of the pointer provide instructions to an operating system and software applications of the electronic device. Additionally, the definition module 212 sets a movement speed threshold for controlling a movement speed of the pointer action on the display screen 11 according to a movement speed of the contact activity on the touch panel 12. The movement speed threshold is stored in the memory system 25. In this embodiment, the control module 216 determines if the pointer continues moving according to the speed of the contact activity relative to the movement speed threshold. As an example, if the movement speed of the contact activity is faster than the movement speed threshold, the control module 216 controls the pointer to move quickly accordingly and directs the pointer to continue moving in a constant direction until the user touches the touch panel 12 again later, and if the movement speed of the contact activity is slower than the movement speed threshold, the control module 216 controls the pointer to move slowly accordingly and directs the pointer not continue moving in the constant direction.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. An electronic device comprising a display screen and a touch panel, the electronic device comprising:
a definition module configured for defining a relationship between contact activity on the touch panel and pointer action on the display screen, setting an activation of a pointer on the display screen corresponding to the contact activity on the touch panel, and setting a movement speed threshold for controlling a movement speed of the pointer action on the display screen according to a movement speed of the contact activity on the touch panel; and
a synchronization module configured for synchronizing the contact activity on the touch panel and the pointer action on the display screen.

2. The device as claimed in claim 1, wherein the electronic device further comprises a sensor, connected to the touch panel, for acquiring analog signals of contact with the touch screen.

3. The device as claimed in claim 2, further comprising:
an acquisition module configured for acquiring analog signals of the contact on the touch panel;
a signal conversion module configured for converting the analog signals of the contact into digital signals of the contact; and
a control module configured for controlling the pointer action on the display screen according to the digital signals of the contact and controlling the activation of the pointer according to the digital signals of the contact activity on the touch panel.

4. The device as claimed in claim 3, wherein the control module controls the pointer action and the activation of the pointer to provide instructions to an operating system and software applications of the electronic device.

5. The device as claimed in claim 3, wherein the control module further determines if the pointer continues moving according to the speed of the contact activity relative to the movement speed threshold.

6. A computer-implemented method for controlling an electronic device via a touch panel, the electronic device comprising a display screen and the touch panel, the method comprising:
defining a relationship between contact activity on the touch panel and a pointer action on the display screen;
setting an activation of a pointer on the display screen corresponding to the contact activity on the touch panel;
setting a movement speed threshold for controlling a movement speed of the pointer action on the display screen according to a movement speed of the contact activity on the touch panel; and
synchronizing the touch panel and the pointer so as to display the pointer on a corresponding location of the display screen.

7. The method as claimed in claim 6, wherein the electronic device further comprises a sensor, connected to the touch panel, for acquiring analog signals of contact with the touch screen.

8. The method as claimed in claim 7, wherein the method further comprises:
acquiring analog signals of the contact on the touch panel;
converting the analog signals of the contact into digital signals of the contact; and
controlling the pointer action according to the digital signals of the contact and controlling the selection of the pointer according to the digital signals of the contact activity on the touch panel.

9. The method as claimed in claim 8, wherein pointer control further directs the pointer action and the activation, to provide instructions to an operating system and software applications of the electronic device.

10. The method as claimed in claim 8, wherein the pointer control further determines if the pointer continues moving according to the speed of the contact activity relative to the movement speed threshold.

11. A computer-readable medium having stored thereon instructions that, when executed by a computer, cause the computer to perform a method for controlling an electronic device via a touch panel, the electronic device comprising a display screen and a touch panel, the method comprising:
defining a relationship between a contact activity on the touch panel and a pointer action on the display screen;
setting activation of a pointer on the display screen corresponding to the contact activity on the touch panel;
setting a movement speed threshold for controlling a movement speed of the pointer action on the display screen according to a movement speed of the contact activity on the touch panel; and
synchronizing the touch panel and the pointer to display the pointer on a corresponding location of the display screen.

12. The computer-readable medium as claimed in claim 11, wherein the electronic device further comprises a sensor, connected to the touch panel, for acquiring analog signals of contact with the touch screen.

13. The computer-readable medium as claimed in claim 12, wherein the computer-readable medium further comprises:
acquiring analog signals of the contact on the touch panel;
converting the analog signals of the contact into digital signals of the contact; and
controlling the pointer action according to the digital signals of the contact and controlling the selection of the pointer according to the digital signals of the contact activity on the touch panel.

14. The computer-readable medium as claimed in claim 13, wherein pointer control further directs the pointer action and the activation to provide instructions to an operating system and software applications of the electronic device.

15. The computer-readable medium as claimed in claim 13, wherein the pointer control further determines if the pointer continues moving according to the speed of the contact activity relative to the movement speed threshold.
